(19) United States
(12) Patent Application Publication
(10) Pub. No.: US 2010/0140486 A1
(43) Pub. Date: Jun. 10, 2010

(54) HIGH RESOLUTION NEAR-FIELD IMAGING METHOD AND APPARATUS

(76) Inventor: JOHN DOUGLAS IDOINE, Mount Vernon, OH (US)

Correspondence Address: MCKEE, VOORHEES & SEASE, P.L.C., 801 GRAND AVENUE, SUITE 3200, DES MOINES, IA, 50309-2721, US

(21) Appl. No.: 12/709,065

(22) Filed: Feb. 19, 2010

Related U.S. Application Data
(63) Continuation of application No. 12/053,801, filed on Mar. 24, 2008, now abandoned.
(60) Provisional application No. 60/919,583, filed on Mar. 23, 2007.

(51) Int. Cl. G01T 1/164; G01T 1/161

(52) U.S. Cl. 250/363.06

(57) ABSTRACT

A device and method are disclosed for imaging. Coded aperture arrays are used in conjunction with macro-collimators, on either side or both sides of the coded aperture arrays, to produce coded images, which are then used to produce a decoded image. Various parameters, including the distances between the radiation source and the code and between the code and the detector, the relative lengths of macro-collimator tubes, sizes of pin-holes in the coded aperture arrays, and number and sizes of the macro-collimator tubes, can be selected to achieve high resolution images of the radiation source. The macro-collimator eliminates wide angles rays and reduces ghost images in the reconstruction. Combining data sets from two gamma camera heads reduces the noise in OSEM reconstruction by improving the definition of object borders. Rotation of the coded apertures eliminates near field artifacts from the Fourier reconstruction of the image.

### CROSS REFERENCE TO RELATED APPLICATIONS

This application is a continuation application of U.S. Ser. No. 12,053,801 filed Mar. 24, 2008 which claims priority under 35 U.S.C. §119(e) to provisional application Ser. No. 60/919,583 filed Mar. 23, 2007, herein incorporated by reference in their entirety.

### FIELD OF THE INVENTION

The present disclosure relates to a method and apparatus for high resolution imaging of an object. In particular, the invention relates to a macro-collimator coded aperture apparatus for near field imaging in an application such as a radiation source in nuclear medical imaging.

### BACKGROUND OF THE INVENTION

In the art of gamma cameras used for medical imaging, a collimator is typically used to allow only gamma rays traveling substantially normal to the face of a position sensitive detector (such as a scintillation detector) to pass through and form part of the constructed image. A collimator is a device which has a large number of narrow hollow tubes arranged in a packed array configuration, and is made of a high density material such as lead or tungsten. The tubes have a length which is typically about 4 to 12 cm, and the tube may be about 1.0 to 3.0 mm in diameter. An image obtained from radiation passing through a collimator represents the radiation intensity field of the object placed in front of the collimator, i.e. radiation intensity (count rate) detected at a particular point on the detector corresponds to the radiation intensity of the object along a line normal to the detector passing through the particular point. The typically long exposure time required to obtain good quality images using a collimator is a weakness, since radiation is only accepted from a very small solid angle, and a gamma radiation source (namely a radioactive isotope) emits radiation at all angles.

Another device used in some gamma cameras is a pinhole aperture, which is a structure not unlike a pinhole aperture in photography. In a gamma camera pinhole aperture, a lead or tungsten shield (usually conical or pyramid in shape) allows gamma rays to pass unobstructed through a small hole aperture at a large range of angles with the effect that the radiation source is imaged on the detector. As with pinhole photography, the image obtained may he enlarged or reduced in size depending on the distance between the imaging system and the object.

Coded aperture imaging systems are also known. A coded aperture imaging system uses a mask consisting of an array of alternating radio-opaque and transparent elements positioned between the object and a position sensitive detector. Examples of coded aperture imaging systems are disclosed in U.S. Pat. No. 4,435,838 to Gourlay patent and an Apr. 14, 1995, publication (2,710,986) in the name of Moretti et al. Instead of having a single aperture through which radiation may pass unobstructed to the detector, the array of transparent elements provide many apertures with the result that the count rate from the same object source is much higher and image acquisition is substantially faster. Coded aperture imaging systems, however, do not yield images on the detector which represent directly the radiation distribution field of the object, and to obtain a useful image, decoding of the position data is required. For example, a single point source will result in a two-dimensional detected distribution (sometimes referred to as a “shadowgram”) which corresponds to the mask pattern, or part of the pattern. For more complex radiation distribution fields, the detected shadowgram is a sum of many such two-dimensional distributions.

In coded aperture imaging systems, there are regions of space where an object source projects a complete shadow of the code (i.e., the mask pattern) onto the detector and others where only a portion of the code is available, since the size of the mask and of the detector are finite. Image reconstruction from partially coded information suffers from various limitations. During image decoding or reconstruction, loss of information from part of the detector or part of the coded aperture affects the whole reconstructed image, since the shadowgrams of the partially coded regions might overlap with the shadowgrams of fully coded regions that would otherwise be correctly reconstructed. This problem in coded aperture imaging is significant in near-field imaging, while for far-field imaging (e.g. gamma ray astronomy) the problem can be less significant.

One possible solution is to place the object at infinity or at a great distance. This has a first drawback of reducing the solid angle subtended by the detector surface with respect to the object source. A second drawback for medical imaging is the difficulty in arranging a patient at a great distance from the detector.

U.S. Pat. No. 6,737,652 to Lanza, Accorsi, and Gasparini (“Lanza et al.”) has presented a method for the reduction of near field artifacts due to the non-stationary point-spread function inherent in coded aperture imaging. Their method requires the acquisition of two sequential images with a 90-degree rotation of a single anti-symmetric coded aperture between the two acquisitions.

Therefore it is a primary object, feature or advantage of the present invention to improve over the state of the art to achieve high resolution images of the radiation source.

A further object, feature or advantage of the invention is to provide a macro-collimator coded aperture apparatus comprising an array of macro-collimating tubes and a coded aperture array for near-field imaging.

A further object, feature or advantage of the invention is the macro-collimating tubes are made of a radio-opaque material.

In another object, feature or advantage of the invention, the radio-opaque material is selected from lead, uranium, tungsten or tungsten-copper alloy.

In yet another object, feature or advantage of the present invention, the radio-opaque material is a tungsten-copper alloy.

In a further object, feature or advantage of the present invention there can be 1 to 100 coded aperture plates.

In another object, feature or advantage of the present invention there can be 20 square coded aperture plates arranged in a 4 by 5 array.

In yet another object, feature or advantage of the present invention, the plates can be 1.5 mm thick copper-tungsten alloy (range 0.5 to 3 mm) for Tc-99 m (140 keV), or 5 mm thick (range 2 to 8 mm) for PET isotopes (511 keV).

In a further object, feature or advantage of the present invention a coded aperture plate comprises 1 to 5,000 pinholes arranged in a square or rectangular multiple uniformly redundant array (MURA). In an example configuration, each coded aperture comprises about 1000 pinholes for 140 keV gamma rays or about 400 pinholes for 511 keV gamma rays.

In a further object, feature or advantage of the present invention a pinhole can be 0.5 to 4 mm in diameter.

In another object, feature or advantage of the present invention a pinhole can be about 1.0 mm in diameter for 140 keV gamma rays or about 3.0 mm for 511 keV gamma rays.

Yet another object, feature or advantage of the present invention a reconstructed image resolution of 3 to 4 mm can be achieved for a field-of-view comparable to the size of the detector.

In another object, feature or advantage of the present invention an image resolution of 1 mm or less can be achieved for a small field-of-view less than 15 cm square.

In a further object, feature or advantage of the present invention the near-field imaging is nuclear imaging.

In yet another object, feature or advantage of the present invention the near field imaging is neutron imaging.

On another object, feature or advantage of the present invention the apparatus can be mounted to any 2-dimensional position sensitive detector.

In another object, feature or advantage of the present invention, the 2-dimensional position detector is a gamma camera.

In a further object, feature or advantage of the present invention, the 2-dimensional position detector is a position emission tomography scanner (PET scanner).

In another object, feature or advantage of the present invention, the coded aperture array is mounted within the array of macro-collimating tubes such that a first portion of the tubes is between the imaging detector and the aperture array and a second portion of the tubes is between the aperture array and the object.

In another object, feature or advantage of the present invention the coded aperture array is mounted at the front of the macro-collimating tubes between the tubes and the object.

In yet another object, feature or advantage of the present invention, the coded aperture array is mounted at the rear of the macro-collimating tubes between the tubes and the imaging detector.

In another object, feature or advantage of the present invention, the imaging detector is a gamma camera and the radiation being imaged is gamma radiation.

In yet another object, feature or advantage of the present invention, the macro-collimator consists of an “n×n” (square) array of square tubes, each of which contains a single identical, square, anti-symmetric coded aperture.

In another object, feature or advantage of the present invention, the entire array of coded apertures is rotated through 90 degrees.

In yet another object, feature or advantage of the present invention, data acquired using the macro-collimator with coded apertures is combined with data from the same object acquired with a second opposing gamma camera fitted with a standard parallel-hole collimator to view the object in the opposite direction to reduce the noise inherent in the coded aperture image.

One or more of these and/or other objects, features or advantages of the present invention will become apparent from the specification and claims that follow.

### BRIEF SUMMARY OF THE INVENTION

The present invention includes novel features which can be used to upgrade existing gamma camera systems by modifying the outer casing and mounting flange to fit the specifications for each camera design. A workstation is required to apply a unique software algorithm that enables the data to be reconstructed into an accurate image with minimal artifacts or interference. Coded aperture arrays are used in conjunction with macro-collimators, on either side of both sides of the coded aperture arrays, to produce coded images, which are then used to produce a decoded image. Various parameters, including the distances between the radiation source and the code and between the code and the detector, the relative lengths of macro-collimator tubes, sizes of pin-holes in the coded aperture arrays, and number and sizes of the macro-collimator tubes, can be selected to achieve high resolution images of the radiation source. Further, the use of coded aperture ensemble rotation eliminates near-field artifacts and wide-angle rays by the macro-collimator.

### BRIEF DESCRIPTION OF THE DRAWINGS

The invention will be better understood by way of the following description of example configurations, some with reference to the appended drawings, in which:

FIG. 1 is a schematic side view of a coded aperture imaging system according to the prior art in which the relative distances between the detector, coded aperture and object source is illustrated.

FIG. 2a is a partly sectional side view of the macro-collimator coded aperture apparatus for use in near-field imaging according to one configuration, in which the coded aperture is sandwiched between front and rear portions of macro-collimating tubes.

FIG. 2b is a partly sectional side view of the macro-collimator coded aperture apparatus for use in near-field imaging according to another aspect of the present disclosure, in which the coded aperture is placed at the front of the macro-collimating tubes.

FIG. 2c is a partly sectional side view of the macro-collimator coded aperture apparatus for use in near-field imaging according to another aspect of the present disclosure, in which the coded aperture is placed at a rear of the macro-collimating tubes.

FIG. 3 illustrates the apparatus of FIG. 2a, 2b or 2c connected to a conventional scintillation camera mounted on a positioner system.

FIG. 4 is a partly break-away view of the apparatus shown in FIG. 2a.

FIG. 5 is a sectional side view of the apparatus shown in FIG. 2a.

FIG. 6 is a plane view of the coded aperture in the apparatus shown in FIG. 2.

### DETAILED DESCRIPTION OF THE PREFERRED EMBODIMENT

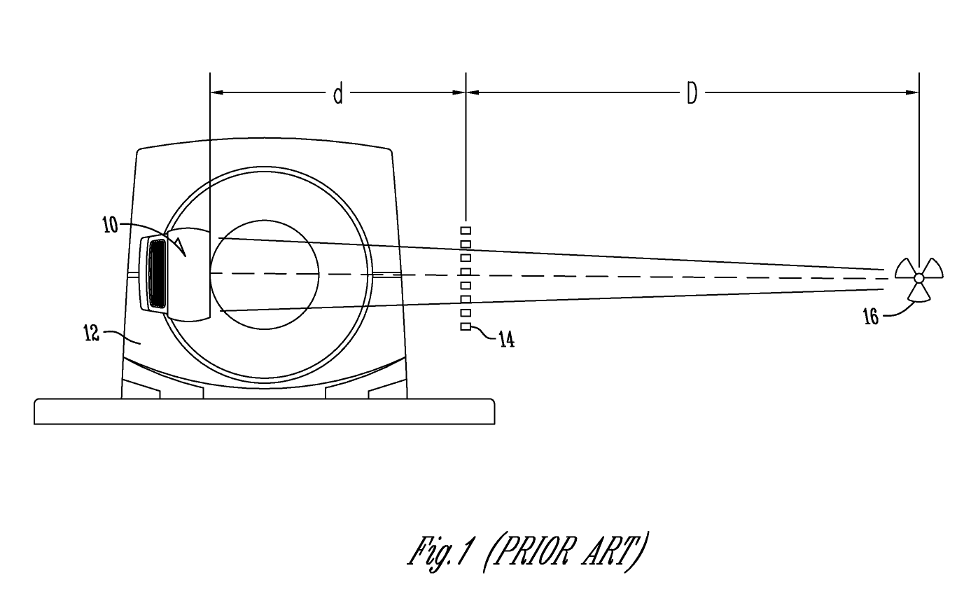

FIG. 1 shows a set-up for medical diagnostic gamma ray imaging in which a scintillation detector is mounted to a positioner gantry system 12 at a distance D+d from a patient providing a source 16 of gamma ray radiation. The patient in gamma ray medical imaging is a patient who has ingested a trace quantity of a radioactive isotope which emits gamma rays detectable by the detector.

In the prior art configuration illustrated in FIG. 1, the detector is stripped of its usual collimator apparatus, and instead, a coded aperture or code device 14 illustrated schematically in FIG. 1, is placed at a distance d from the detector in the field of view of the detector. Gamma rays emitted from the source 16 may only pass unobstructed through the pinholes in the code 14, whereas due to the high density of matter in the radio-opaque material surrounding the pinholes in the code 14, Gamma rays of the energy emitted by the source 16 are not able to pass through the radio opaque portions of the code in any statistically significant quantity. As is known in the prior art, the image formed on the detector 10 is the result of the superposition of images formed by each individual pinhole in the code and the count rate or intensity distribution function detected by the detector 10 must be decoded to produce a reconstructed image.

The system resolution for a coded aperture can be defined as the product of the intrinsic resolution of the detector and the quotient of the distances D and d (D/d). In the Verista Systems' Smart Digital detector, the typical intrinsic spatial resolution is 2.7 mm full-width half-maximum at 140 keV (e.g. gamma photons from 99 mTc). With a standard collimator gamma camera, the system resolution is about 9 mm under normal imaging conditions. Larger magnification can be obtained if the object source is closer to the code. However, a larger source-code distance is desirable to decrease angular distribution.

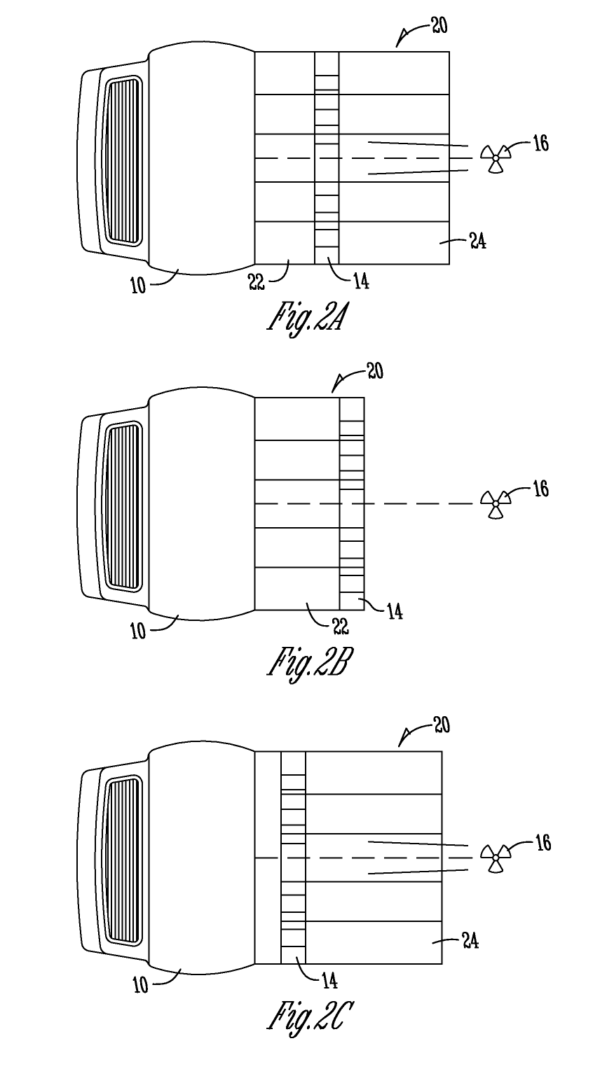

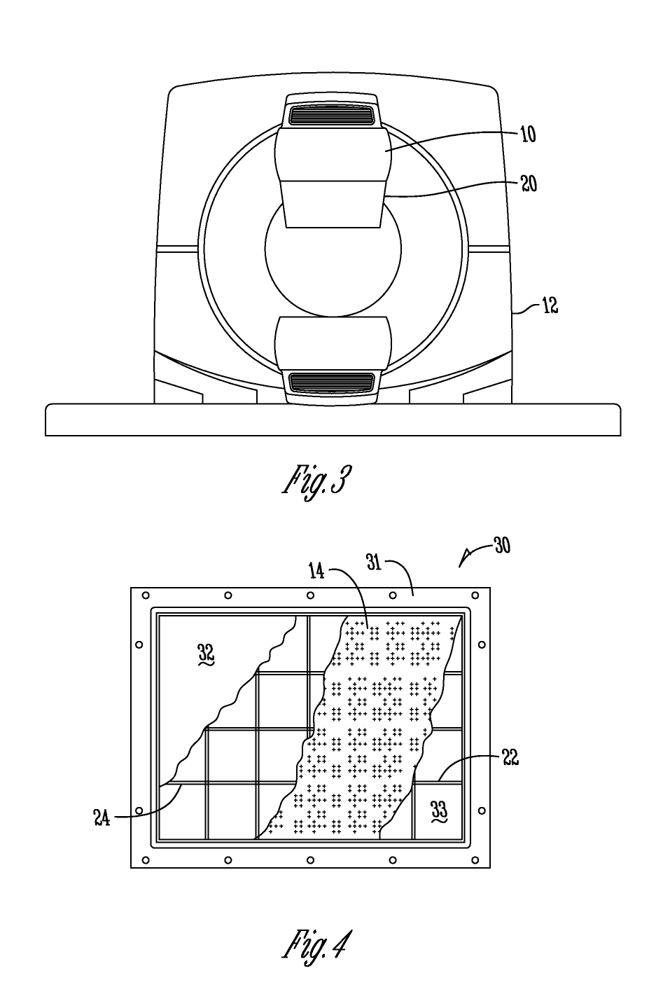

Thus, in accordance with an aspect of the present disclosure, the actual distances D and d are selected to meet: (1) the smallest possible magnification ratio, d/D, so as to obtain less than 4 mm system resolution and greater than one so that any given point projects a full shadow of the code onto the detector (one full code being defined as any quadrant of the code plate); and (2) the smallest possible D+d so that the box size is convenient for medical imaging (see FIG. 3). In the configuration illustrated in FIG. 2a, a macro collimator device 20 is mounted to the scintillation detector 10. The macro collimator coded aperture apparatus has an array of macro collimating tubes 22 mounted to a face of the detector to which the coded aperture array 14 is mounted. On the face of the coded aperture array 14, a second series of macro collimating tubes 24 is mounted such that the array of tubes 22 and the array of tubes 24 are coincident. The tubes may be arranged in a square or rectangular matrix or they may be arranged in other patterns, such as a hexagonal honeycomb pattern.

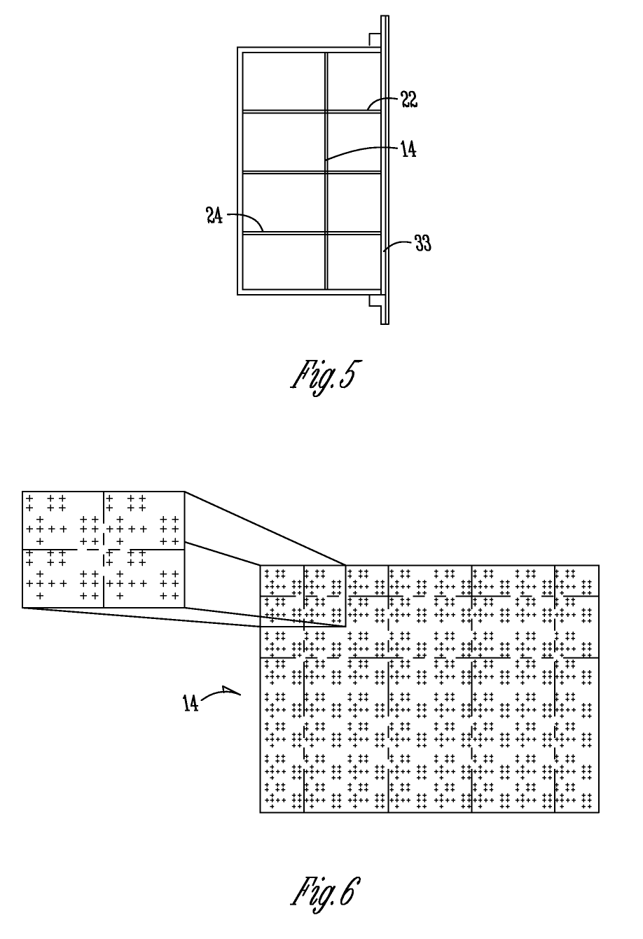

As is better illustrated in FIGS. 4 and 5, the number of tubes in the configuration is 24, the array of macro collimating tubes consisting of 4 rows by 6 columns of tubes having a square cross-section with sides measuring approximately 10 cm by 10 cm. The length of the tubes 22 is 10.0 cm and the length of the tubes 24 is 5.0 cm. Other relative lengths between the tubes 22 and 24 can be used. For example, configurations ranging from for tubes 22 of finite lengths, with no tube 24 (i.e., zero length for tubes 24), to no tube 22 (i.e., zero length for tubes 22), with tubes 24 of finite lengths, can be used. In addition, either or both of the tubes 22 and 24 can have variable tube lengths to facilitate system tuning. The code 14, which is illustrated only schematically in FIG. 2a, has a thickness of 1.0 mm. The apertures in the code 14 may be circular holes having a diameter of 1.0 mm.

In the configuration shown in FIG. 2a, a plurality of holes are provided within each tube. In one aspect of the present disclosure, a multiple uniformly redundant array (“MURA”) of holes, as illustrated in FIG. 6, are provided. Uniformly redundant arrays are known in the art, as for example, in the article entitled “Coded Aperture Imaging With Uniformly Redundant Arrays” by Fenimore et al, published in Vol. 17, No. 3, of Applied Optics, February 1978, the subject matter of which is incorporated herein by reference.

The material used for the macro collimating tubes in the example configuration shown in FIG. 2a is tungsten/copper alloy. However, other suitable material for collimators can be used. Examples include the thickness of the walls of the tubes 22 and 24 is 1.0 mm for 140 keV gamma rays. The mounting of the aperture apparatus 20 to the detector face in the preferred embodiment is a mounting compatible with standard mountings for collimators. The construction of these is known in the art and may vary from manufacturer to manufacturer of such scintillation detectors. As shown in FIG. 4, the apparatus 20 has an outer casing 15 including a mounting flange 31, and a front cover sheet 32. When removed from the imaging detector 10, the casing 30 is an open box with a thin transparent cover sheet 33 on top. The tube walls 22 are made of interlocking horizontal and vertical sheets of tungsten/copper alloy. The tubes 22 rest on the aperture plate 14. By removing the cover sheet 33 and the tubes 22 access may be gained to the aperture plate 14. The plate 14 may be replaced to change thickness or aperture configuration. The tubes 24 are provided in a similar manner using interlocking tungsten/copper alloy sheets. The plate 14 rests on top of the tubes 24 and the tubes 24 rest on the front cover 32. The full thickness of the apparatus 20 is about 15 cm (a range of about 15 cm to 35 cm is suitable), and the ratio of D:d is about 1:1. For a near field-of view scan, the patient undergoing medical imaging is placed immediately in front of apparatus 20.

In the variant configurations illustrated in FIGS. 2b and 2c, the macro collimating tubes are provided only on one side of the code 14. In the embodiment illustrated in FIG. 2b, the macro collimating tubes 22 are provided between the detector 10 and the code 14 only, and in the variant embodiment illustrated in FIG. 2c, macro collimating tubes 24 are provided between the code and the front of the aperture apparatus 20 while a space between the code 14 and the detector surface is provided by the outer shielding shell of the apparatus structure.

As shown in FIG. 3, the aperture apparatus according to the invention can be mounted to a conventional gamma camera 10 much like a conventional collimator, although its thickness may be as much as 2 or 3 times the thickness of a conventional collimator. In the embodiment shown in FIG. 3, the patient's body containing the source 16 would be placed immediately in front of apparatus 20 for near field imaging.

The present invention further improves upon the prior art wherein the macro-collimator consists of an “n×n” (square) array of square tubes, each of which contains a single identical, square, anti-symmetric coded aperture. These identical coded apertures 14 are drilled into a single sheet of machineable and self-supporting tungsten-copper alloy, such as Kulite or similar composition. The entire array of coded apertures may then be rotated through 90 degrees simply by rotating the entire sheet. Since the coded apertures are identical and square, the 90-degree rotation of the entire sheet will have the same effect as rotating each coded aperture individually about its center. During the rotations of the sheet through 90 degrees, each coded aperture will move to a new tube in the macro-collimator and will be rotated by 90 degrees relative to the coded aperture previously occupying that position. This arrangement allows the image to benefit from both the elimination of near-field artifacts by coded aperture rotation described by Lanza, et al., and the elimination of wide-angle rays by the macro-collimator as described above, as well as, allowing the use of faster Fourier deconvolution reconstruction algorithms with macro-collimator data. Data using radioactive Tc-99 m and a Verista imaging gamma camera show that the combination of the macro-collimator with the rotation of the coded apertures yields better images of phantoms with fewer ghosts and other near-field artifacts than either technique when used alone.

Further, data acquired using the macro-collimator with coded apertures may be combined with data from the same object acquired with a second opposing gamma camera which is fitted with a standard parallel-hole collimator which views the object in the opposite direction from the opposite side. The two gamma camera heads so equipped may be stationary, or may rotate about the object acquiring multiple data sets from different directions. The combined data sets from the two gamma camera heads may be reconstructed using an iterative Ordered Subsets Expectation Maximization (OSEM) algorithm which minimizes differences between the expected and observed data on both detectors. Data acquired using a dual-head Park gamma camera and radioactive Tc-99 m demonstrated that the OSEM reconstruction of the combined data yielded images which were clearly superior to those obtained with either the macro-collimator or the parallel-hole collimator alone. The reason for this improvement is believed to be the higher resolution provided by the coded apertures in the macro-collimator combined with the additional information about the boundary of the object provided by the parallel-hole collimator data. Coded aperture images are often plagued by noise covering the image because stochastic noise from highly radioactive regions of the object is spread over the entire image. The improved definition of the object border provided by the addition of the parallel-hole data allows the OSEM algorithm to eliminate this noise from the image.

While particular configurations have been described in the present application, it will be understood by those skilled in the art that the invention is not limited by the particular configurations disclosed and described herein. It will be appreciated by those skilled in the art that other components that embody the principles of the invention and other applications therefore other than as described herein can be configured within the spirit and intent of the invention. The configurations described herein are provided as only examples that incorporate and practices the principles of this invention. Other modifications and alterations are well within the knowledge of those skilled in the art and are to be included within the broad scope of the appended claims.

What is claimed is:

1. A macro-collimator coded aperture apparatus for use in near-field imaging of an object, the apparatus comprising:
an array of macro-collimating tubes made of a radiopaque material;
a coded aperture array; and
means for mounting the coded aperture array at a fixed distance from an imaging detector and for mounting the macro-collimating tubes at a fixed distance from the detector, the tubes being aligned in a direction of a field of view of the imaging detector, whereby the imaging detector obtains a number of restricted field of view images each having reduced artifacts due to shadows of the coded aperture array projected by radiation coming from the object.

2. The apparatus as claimed in claim 1, wherein said coded aperture array is mounted within said tubes such that a first portion of said tubes is between the imaging detector and the aperture array and a second portion of said tubes is between the aperture array and said object.

3. The apparatus as claimed in claim 2, wherein said mounting means comprise a box-like casing adapted for mounting to said imaging detector and in which said coded aperture array and said tubes are mounted.

4. The apparatus as claimed in claim 3, wherein said coded aperture array and said first and second portions of said tubes are removable from said casing.

5. The apparatus as claimed in claim 2, wherein a length of said second portion is variable and approximately twice a length of said first portion.

6. The apparatus as claimed in claim 3, wherein a length of said second portion is variable and approximately twice a length of said first portion.

7. The apparatus as claimed in claim 6, wherein a total length of said first and said second portions is about 15 to 30 cm.

8. The apparatus as claimed in claim 1, wherein said tubes are made of at least one of tungsten, lead and uranium or an alloy of these materials, such as the tungsten and copper alloy referenced in the summary of invention above.

9. An imaging aperture apparatus for use in near-field imaging of an object, the apparatus comprising:
an array of collimating tubes made of a radiopaque material aligned in a direction of a field of view, said collimating tubes allowing radiation to pass therethrough within a small range of angles with respect to said direction;
a radiopaque stop plate mounted to said array of tubes transversely to said direction, said stop plate having at least one aperture positioned within at least some of said tubes, whereby the imaging detector obtains a number of restricted field of view images each having reduced artifacts due to shadows of the coded aperture array projected by radiation coming from the object.

10. The apparatus as claimed in claim 9, wherein said plate is mounted within said tubes such that a first portion of said tubes is between the imaging detector and the stop plate and a second portion of said tubes is between the stop plate and said object.

11. The apparatus as claimed in claim 10, wherein said apparatus further comprises a box-like casing adapted for mounting to said imaging detector and in which said stop plate and said tubes are mounted.

12. The apparatus as claimed in claim 11, wherein said stop plate and said first and second portions of said tubes are removable from said casing.

13. The apparatus as claimed in claim 10, wherein a length of said second portion is variable and approximately twice a length of said first portion.

14. The apparatus as claimed in claim 11, wherein a length of said second portion is variable and approximately twice a length of said first portion.

15. The apparatus as claimed in claim 14, wherein a total length of said first and said second portions is about 15 to 30 cm.

16. The apparatus as claimed in claim 9, wherein said tubes are made of at least one of tungsten, lead and uranium or an alloy of these materials, such as the tungsten and copper alloy referenced in the summary of invention above.
